(19) United States
(12) Patent Application Publication
(10) Pub. No.: US 2008/0231058 A1
(43) Pub. Date: Sep. 25, 2008

(54) Kite Power Generator

(76) Inventors: Kit Nicholson, Kirkby Lonsdale (GB); Hamish Nicholson, Carlisle (GB); Marc Ricketts, Portland, OR (US)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 12/067,606

(22) PCT Filed: Sep. 22, 2006
(86) PCT No.: PCT/GB2006/003518

§ 371 Date: Mar. 20, 2008

(30) Foreign Application Priority Data
Sep. 22, 2005 (GB) 0519354.5
May 2, 2006 (GB) 0608548.4

(51) Int. Cl. F03D 5/06

(52) U.S. Cl. 290/55; 244/153 R

(57) ABSTRACT

The Kitepower Generator uses one or more kites that go through a oscillating cycle of motion creating varying forces on their tether lines. These varying forces are converted into rotation, using a crankshaft. The cycle of motion may be driven by the inherent kite design or through the action of two or more tether lines connected to a crankshaft. The pull from the lines is stronger when they pull out and weaker when they are being pulled in. The cycle of motion may involve flapping, swirling, waving, swooping, veering or feathering. Several kites may be connected or combined into a single composite kite. Efficiency is higher with three or more lines so that one is always pulling out strongly. Various techniques keep kites aloft in still or stormy weather.

### BACKGROUND

Conventional wind turbines generate power from rotating blades mounted on towers. This means that they have to be large structures, which are often considered unsightly. They are also expensive to construct and there are economic and engineering limits to the height of the towers and hence to the ability to harness faster and more reliable winds at higher altitudes. It is also claimed that the rotating blades can harm birds in flight.

It is an object of the present invention to obviate or mitigate at least one of the problems associated with the prior art.

### STATEMENT OF INVENTION

According to a first aspect of the present invention there is provided a range of kites that generate varying patterns of forces on the tether or tethers to which they are connected.

Preferably, these kites involve a pattern of forces that is generated by: flapping; swirling; waving; spinning; changing angle of attack; feathering or venting, moving in a repeated path through the sky; or auto-gyrating.

According to second aspect of the present invention there is provided a range of devices to enable a kite or kites to stay aloft in still air or in weak or strong winds.

Preferable, these kites use methods involving: lighter than air substances; masts; automatic reeling; elastic kite materials; structurally adaptation; powered reverse crankshaft rotation; cables; stretchable lines; and mechanically shortened lines.

According to a third aspect of the present invention, there is provided a range of methods for connecting the kites, with or without idling devices, to a conversion device which converts the varying forces into rotational or other useful motion.

Preferably, this conversion device is based on a crankshaft.

To overcome the disadvantages of conventional wind turbines, ‘kitepower’ generators use kites that are tethered to a device such as a crankshaft that converts a regular pattern of varying forces on the kite lines into a rotational force, whilst at the same time controlling the movement of the kites in order to maintain the regular pattern of forces. If the wind is light, various techniques are defined for keeping the kite aloft.

### ADVANTAGES

Generators that use a kite to generate power (i.e. kitepower generators) have several important advantages over conventional wind turbines: they are cheaper to build and easier to dismantle; they make it possible to harness the stronger and more constant winds that are found at higher altitudes, further reducing the costs of power generation; and they are less intrusive in the landscape and provide less risk of harm to birds.

The construction of the kites and crankshaft can vary in complexity and size to suit budgets and wind conditions.

Other advantages of the apparatus and method according to the present invention will be apparent to the skilled person from the drawings and the description of those drawings that follow.

### INTRODUCTION TO DRAWINGS

Embodiment of the present invention will now be described, by way of example only, with reference to the accompanying Figures, in which:

FIG. 1 depicts the basic principle of kitepower generation, using an embodiment with two flapping kites, four lines and a crankshaft with four crankpins;

FIG. 2 depicts an example of a crankshaft in more detail;

FIG. 3 depicts a similar embodiment to FIG. 1, but with the kites going through a swooping cycle, rather than a flapping cycle;

FIG. 4 describes a different embodiment, with a single composite ‘swirling’ kite, six lines and a crankshaft with six crankpins;

FIG. 5 describes another embodiment of a composite kite;

FIGS. 6a and 6b describe a device which can be located in-between the crankshaft and the kites, to allow a large number of lines to be used, without increasing the number crankpins;

FIGS. 7 and 8 describes a third embodiment of a composite kite;

FIG. 9 describes a system where a kite moves through the air and, in so doing, goes through a pattern of forces that can be used to generate power;

FIG. 10 describes the use of an auto-gyro kite; and

FIG. 11 describes an example of a structured lighter than air aerofoil shape.

### DETAILED DESCRIPTION

Kitepower generators use one or more kites that are connected by one or more lines to a device on the ground that converts a pattern of forces in the kite lines into a movement from which power can be generated. Kites are defined as objects that are flown in the air or in other gases or fluids, such as water, on the end of one or more tether lines, using wind to create a pull on the line.

In most cases, the movement from which power can be generated is rotational, and the conversion device may be called a rotatable device. One useful version of the rotatable device is a crankshaft, which is defined as a structure that allows a set of crankpins to rotate around an axis of rotation without the need for an axle running through the axis of rotation. However, other movements may also be used, such as a see-saw motion on one or more levers.

There are a number of different options for the cycle of motion in the kite(s). All these options involve changes in the pull of the kite(s), so that the pull is lower when the line(s) are being pulled in to the conversion device and higher when the line(s) are being pulled out from the conversion device.

In one set of designs, which may be termed ‘mechanical’, the cycle of motion is caused by the relative movement of the tether lines. This set of designs is particularly suited to operate with a crankshaft, though other conversion devices, such as ratchets, may also work. The configuration of the kite(s), lines and the crankshaft, establishes a cycle of motion in the kite(s) to change the shape or orientation of the kite(s), with differential forces on the lines being used to maintain the rotation of the crankshaft, which itself controls the cycle of motion through the relative position of the kite lines. The pull is determined largely by the shape and angle of the kite which is controlled by the relative position of the kite lines. The line which leads the pulling in motion may be called the ‘tether line’, and the other line may be termed the ‘power line’. The crankpin(s) for the tether line(s) are in advance of the crankpin(s) for the power line(s), in the direction of motion of the crankshaft, when generating power. The angle by which each tether line is in advance of its corresponding power line may be between 0 and 180 degrees, depending on the nature of the kites. The positions of the crankpins for the tether line of each kite is such that they are offset from each other by an equal angle. The same is true of the positions of the power lines of each of the kites. The positions of the crankpins should ensure the smoothest possible power generation and will depend on the distance of movement required to change the profile of the kites. A flywheel can be attached to the crankshaft to ensure a smoother motion.

In summary, the generation of rotational motion is passive and continuous (so long as the kite is located in an air flow). When the conversion device moves, or rotates, it causes the kite to change shape or orientation, and when the kite does this it causes the conversion device to rotate.

In a second set of designs, which may be termed ‘organic’, the design of the kite itself incorporates features that put it through an inherent regular cycle of movement, without the controlling influence of the lines. As with the first set of designs, the varying forces are captured using a conversion device, such as a crankshaft or ratchet.

The means by which the kite inherently forces itself through a repeated cycle of movement may include, for example: vibrations; external vents or flaps that open and close during the cycle; flexing spars that coil and recoil; internal divisions in the kite that allow some air, or another gas, to move within the kite; tails or subsidiary kites that veer in a regular manner, pulling the parent kite; and spinning devices that influence the kite's behaviour. Kites that go through inherent cycles of movement can be relatively unstable and it may therefore be particularly important to incorporate into their design lighter-than-air substances or secondary kites, to ensure that they always recover their height in the sky.

In the simplest of examples, a kite incorporates a single tensioned strip of material which is lined to face the wind and which vibrates in the wind. Lines are attached to the vibrating strip so that every time they pull outwards a pulse of force is transmitted down to the crankshaft or ratchet. Spinning is also a useful method of generating organic behaviour. Because spinning components in kites often do not generate great force, it may be useful to gear their force through a system of winding control lines onto a spool for a number of rotations and then using a device to release the line after a set number of rotations. For example, the spool onto which the control line is wound may be locked onto the spinning axle by a sprung clip and the spool may be grooved so that the line wind up in a spiral manner and dislodges the clip and releases the spool when the control line winds up to end of the spool. Another example of harnessing inherent motion is the use of the bowl kite which is well known to rise and fall in the air in a regular pattern, thus delivering a pattern of varying forces.

If the inherent movement cycle incorporates a degree of irregularity, it may be useful to use ratchets rather than crankshafts, with each ratchet attached independently to a single axle, so that each ratchet can give a separate force, whenever it is pulled out and can then by pulled back independently of the other ratchets.

Cycle of Movement. The invention uses eight different categories of kite, each of which involves a repeated pattern of forces on the lines, caused by different processes. These categories are: i) flapping kites; ii) swirling kites; iii) waving kites; iv) spinning kites; v) kites with changing angle of attack; vi) feathering or venting kites; vii) kites moving in a repeated path through the sky; and viii) auto-gyro kites.

In flapping kites, the variation in pull on the lines can be caused in two ways. First, it may be caused by changes in the angle of the wings to the wind, thus causing changes in drag and lift forces on the wings. Second, it may involve changes arising from the movement of the wings up and down in the air, without changing the angle to the wind, thus causing variation in the lift force on the wings. The variations may also involve a combination of these two reasons for varying forces.

As with most of the other categories of movement cycle, flapping kites may either be controlled mechanically by the action of two or more tether lines, or they may flap as a result of the inherent design of the kite. With a two line flapping kite, where flapping is mechanical, one line is attached to the central part of the kite. There are two options for the second line. Firstly, it may splits into two and be attached to either side of the central part of the kite, nearer the end of the wings, at a point that provides the optimal leverage on the wing. Secondly, it may pass through the centre of the kite up to a shoulder and then down to the wing from behind, mimicking the way birds' muscles control their wings in flight.

In surfing kites, the variation in pull is caused by a swirling motion around a central point or area of the kite. Two or more tether lines are attached around the periphery of the kite and are then attached to crankshaft. The forces on one side of the kite are stronger than on the other side with the side exposed to stronger forces pulling out while the opposite side is being pulled in. The device operates in a manner where the point on the kite with the strongest force progresses round the central point or area. The swirling motion may be caused by flaps or wings or by the kite changing its form and profile to the wind, for example by allowing some of the faces to be attached to sliders, which are allowed some space to run along rods or tensioned lines. The peripheral parts may also take a continuous form, similar to a skirt, with one side of the skirt sticking out and pulling back strongly, whilst the opposite side is in line with the wind and is being pulled in. The part of the kite that sticks out and pulls strongly will migrate around the centre of the kite in a manner reminiscent of a swirling skirt. The number of tether lines used will depend on the number of moveable parts in the composite kite.

The central point of the kite remains still. It may be useful to tether the central point of the kite, to provide added stability. This may also be useful in launching the kite. The single swirling kite may incorporate design elements from other kites, including kites which flap or change their angle of attack. The swirling kite may also take the form of a structural frame onto which different kites can be mounted. For example, three flapping kites could be mounted and rigged to a crankshaft so that they each flap in turn, generating a rhythm around the kite which causes a swirling migration of the forces on their tether lines around the central point of the frame.

The purpose of linking these into a single composite swirling kite is to increase the stability of the system and/or reduce the risk of collision and entanglement when separate kites are used. To improve the stability of the swirling kite, the central stable parts may incorporate features, such as tetra cells, that generate lift and reduce spin. Stability may be further improved by attaching the top side of the central point to a separate lifting force, such as provided by a second kite or a balloon.

In wave kites, the variation in pull is caused by a wave motion progressing through the kite. In one example of this design, the kite consists of a horizontal aerofoil shape connected by several pairs of lines to a crankshaft, with one line near the front of the aerofoil and one nearer the rear. As the crankshaft rotates, one part of the aerofoil is catching the wind and being pulled back strongly, whilst another part is being pulled in, to glide down with relatively little lift and/or drag. The design of the crankshaft determines the nature of the wave motion and the lines must be rigged to the kite in a manner that ensures that the forces on the crankshaft are balanced, to make sure that the crankshaft does not get stuck with one line pulling more strongly than the balance of other forces. In a variant of this category, the crankshaft includes a central pair of crankpins, with symmetrically offset crankpins on either side, so that the wave motion in the kite spreads from a central point to each end of the kite, thus helping to promote a balanced operation. Wave kites may include a structure within the kite that maintains the spread of the kite and bends to regularise the wave motion. If this structure is flexible, it may include some recoil forces which can be useful in establishing a regular pattern of force. Wave kites may be constructed from a continuous single kite or a connected number of elements.

With spinning kites, the kite rotates in an axis perpendicular to the force of the wind and this causes variation in the pull from the kite. In some kite designs, this causes the kite to rise and fall in the sky without further mechanical control and this behaviour causes a varying pull, which can be harnessed using a crankshaft or other similar device. A common example of the spinning kite is the bowl kite, which is well know to rise and fall in the air. With some kites, including the bowl kite, the rising and falling cycle includes a period when the kite falls to the ground, where it exerts no pull, and then rises automatically, when refilled with air.

With kites which change their angle of attack, the strength of the force changes with the angle of attack, either through changing drag, at low angles of attack or through changing lift, at high angles of attack. Many kites can be mechanically controlled by two or more lines to change their angle of attack, thereby setting up a regular pattern of forces. In the simplest version of this, a kite has two tether lines, one attached near the nose and one near the tail of the kite. As these lines are pulled in and out by the crankshaft, they change the angle of attack of the kite, thereby causing a pulling pattern which reinforces the movement of the crankshaft.

In a variation of this category, the angle of attack is organically determined by the design of the kite, enabling the kite to generate a variable force on a single line. The pattern of changing angle of attack may create a repetitive swooping motion. In a special case of this category, the changing cycle of the kite may include a stall. For example, in many single line kites, attaching the tether line too close to the nose of the kite causes the kite to pulling strongly up through its arc of flight and then to continue into a stall, before being caught again by the wind and lifted back through its arc of flight. This behaviour can be harnessed using a large diameter crankshaft or a ratchet.

Patterns of changing angle of attack my involve very rapid movements, as well as the slower rising and falling of a kite. In the extreme, the movements may become vibrations and these may be harnessed by rapidly moving low diameter crankshafts. In one example of this, the natural tendency of a strip of material to vibrate when it is held tensioned in line with the wind, can be exploited by attaching tether lines the leading and/or trailing edges. If the crankshaft is carefully synchronised with the vibration frequency and wavelength, it can also reinforce the vibration. In this example, the kite power generator is behaving in a manner more similar to the inverse of insect flight than bird flight.

With kites incorporating feathers or vents, the resistance of the kite is determined by the changing positions of the vents or feathers. The change in position may be determined either mechanically by the use of two or more lines or organically through devices incorporated into the design of the kite. For example, a kite may incorporate a set of vents which are layered in a manner similar to a venetian blind. A spinning device on the kite, such as an autogyro or anemometer, can be used to wind up a control line that gradually closes the vents, thus causing the kite to pull out increasingly strongly. After a set number of revolutions, the control line can be automatically released, allowing the vents to flap open and the kite to be pulled forward in the air with little resistance.

Kites made exclusively from a system of opening and closing vents will not normally behave in a stable manner. To improve the stability of such kites, it can be useful to integrate the vents into a kite design which is naturally stable, such as a cody. When the vents are incorporated into the interior of a stable kite, such as a box kite, they may be held at both ends and operate like a blind. They may also be incorporated on the periphery of the kite, when they will operate like feathers. The vents may be structured aerofoil shapes and will then behave in a similar manner to feathers.

With kites that go through a cycle of movement in the sky, the pull from the kite varies with the position in the cycle of movement. Many kites can be made to go through a figure eight movement through control on two lines and the force from the kite is strongest at the points when the kite passes across and down the arc in both directions. This cycle can be set up when the kite lines are attached to the crankshaft, with the diameter of the crankshaft set at an appropriate size to ensure the correct relative movement of the lines and the rotation of the crankshaft taking place relatively slowly.

Autogyro kites use spinning, self-adjusting rotor blades that create lift, attached to a spindle which helps provides stability. If the spindle and blades are made to change their angle of attack, the level of lift is reduced and the variation in lift can be harnessed using the crankshaft. The change in angle of attack can be controlled mechanically through the use of two or more lines attached to the crankshaft, or organically, through the addition of a device which provides alternating resistance.

Spinning autogyros can be useful devices for generating organic movement in the kites, because they create lift whilst also generating the spinning movement that can control organic movement. One example of an organic configuration involves two autogyros spinning one behind the other. The first is tethered in the normal manner, by a single line attached to the spindle. The second is attached to the first by two control lines, one high on each spindle and the other lower on each spindle. The higher control line is attached to both spindles by a bearing that allows the spindle to spin without winding the control line. The lower control is attached to one spindle with a bearing, as with the first control line, but is attached to the other spindle on a ratchet spool which allows the line to wind round the spool for a set number of turns, at which point an automatic release device is activated which allows the spool to unwind. While the second control line is being wound in, the shafts of the two autogyros are bought together at the bottom, thus causing them to lean back both in the wind. This reduces the pull on the main tether line. When the second control line is released, the autogyros return to a vertical position and to the point of maximum lift and pull. The device can be maintained aloft by connecting structured light than air aerofoils above each autogyro.

For more power, a system of stacked kites can be used. In this case, the kites described above can be considered ‘parent-kites’, with one or more ‘child-kites’ flying above their parent-kites and attached directly to the parent kite (or child kite) below. Large kites can be more difficult to construct than a number of smaller stacked kites with the same combined wing area. By attaching child-kites directly to parent-kites, it is possible to avoid the proliferation of lines attaching the kites to the crankshaft, therefore reducing the risks of the lines becoming entangled. The stacking of kites may also help to reduce problems of line stretch, caused either by the physical stretching of the lines or by the straightening of their degree of curvature, due to wind resistance.

When two or more kites are involved, the kites are rigged to maintain a safe distance from each other in the sky so that they do not clash with one another. It will be appreciated that the lines attaching the kites to the crankshaft are attached at a position on the kite that ensures that the average angle of the kites to the ground maximises the power generated, without being so close to the ground that the kites become unstable, risking collapse. It will also be appreciated that the relative attachment positions of the power lines and tether lines to the kites is related to the diameter of the crankshaft that is required to generate a full motion cycle. The ideal distance is determined by the need to keep the diameter of the crankshaft relatively small, to minimise twisting forces in the crankshaft, whilst also avoiding excessive leverage forces on the kites or parts of kite that are moving (e.g. the wings of a kite).

Idling. Kite power generators may incorporate a number of features which allow the kites to remain idle in the air during periods when there is either not enough wind or if the wind is too strong for the kite to go through its normal cycle of motion. These methods include using: lighter than air substances; masts; automatic reeling; elastic kite materials; structurally adaptation; powered reverse crankshaft rotation; fixed cables; stretchable lines; and mechanically shortened lines.

Lighter than air substances, such as helium and aerogels, can be incorporated into kites as an integral part of the structure of the kites to allow them to float in weak winds or still air. Existing use of helium filled aerofoils tends to produce bulky shapes that are relatively inefficient, especially in strong winds. By using tensioned aerofoil structures, it is possible to enclose more streamlined spaces with lighter than air substances, thus ensuring that a kite can stay aloft in high winds as well as low winds. Another method of producing more streamlined structured aerofoil shapes is to use a lightweight micro-pore latticed material, such as foam.

Structured aerofoil kites will still have a maximum operating wind, above which they will move to an idling position. Improved structure to lighter-than-air kites may also be achieved through the use of substances such as foams which provide very light lattice structure within which lighter than air gases can be contained, either with our without an exterior sealing film. Lighter than air substances eventually leak through fabrics and it would be necessary to land the kite at regular intervals to replenish the lighter than air substance.

Separate structured aerofoil shapes may be used in a similar manner to feathers, by building up a number of similar shapes and connecting them together. When these feather shapes are also filled with a lighter than air substance, they will help to ensure that the kite stays aloft in still and light winds.

Kites can operate at the top of masts so that they stay aloft in low and high winds, ready to relaunch in favourable conditions. Masts will be much lighter than the towers required for conventional wind turbines because the kites have very little weight. Masts can be tubular, made, for example, of carbon fibre, or a lightweight lattice.

Another option for allowing kites to remain aloft in low and high winds is to use a reeling device that detects the force from the kite or the wind speed and automatically reels in the kite at low and high winds. In order to facilitate automatic relaunch, the kites may be captured in a cradle device which allows them to be released in favourable conditions. The cradling process can incorporate a mechanism for automatically protecting the kite in high winds, for example by furling the kite or erecting shelter devices. The cradling device can also incorporate a device to ensure that the kite and cradle always face into the wind. The cradling device may be attached to the top of a mast to facilitate automatic relaunch.

Kites may be partly or whole made of an elastic material that allows for a degree of automatic furling to take place in stronger winds. Kites may also incorporate features which allow the structure of the kite to change shape in different winds, to help the kite to deal with low and high winds. These can include automatic vents, slide mechanisms for the kite spars or bridles and sprung hinges.

Some kite designs can be made to stay aloft by applying power to the crankshaft to reverse the direction of rotation, thus forcing the kite into an opposite cycle of motion which generates lift. For example, in lift-based flapping kite systems, reversing the motion of the crankshaft will cause the kite to behave like a bird in flight. In some circumstances, it may be efficient to use a cable strung between two structures of landscape features and to attach the kite or kites to this cable, so that it remains in one position. This could include a cable attached between two sides of a valley or between buildings and trees.

Two systems may be used for varying the length of the kite lines to allow the kite to adopt an idling position in weak and strong winds or in still air. In one option, some or all of the kite lines incorporate some built in stretch that changes their relative lengths. In the second option, mechanical devices are activated which pull in some or all of the lines when there is little or no wind.

Crankshaft. In the simplest configuration, the crankshaft has two crankpins, each crankpin being connected to a different position on a single kite by a line. This configuration is equivalent to a single piston engine and suffers from the same limitations. In particular, the momentum of the crankshaft has to carry it round when the lines are being pulled in. Having two kites, each kite having two lines each connected to one of four appropriately separated crankpins improves the system, but three or more pairs of crankpins is even better, for reasons that are similar to the superior performance of three and four cylinder combustion engines. Kitepower generators therefore operate in a way that is similar to conventional internal combustion engines, with the explosion in a combustion engine equivalent to the stronger pull of the kite when it's shape or orientation is changed so that it's resistance to the wind increases (e.g. when the kite is made to be square to the wind).

It can be useful to add a variety of devices to the crankshaft to alter the relative movement of the tether lines. For example, a device may be placed in front of the crankshaft that consists of elliptical shaped discs mounted on an axle that is connected to the crankshaft using a timing chain. As the elliptical shaped discs rotate, they push some of the tether lines out of their normal alignment, thus shortening them and changing the behaviour of the kites to accelerate one part of the kite's cycle. Another method of achieving this effect is for levers attached to the crankpins to swing out as the kite is in transition between the strongest and weakest pulling phases.

In most crankshafts, the crankpins are each the same distance from the axle of rotation. However, in kite power generators, it may be useful to vary this distance in order to allow different gearing to the movement of the kites.

Additional devices may be added to the crankshaft to change the way in which it alters the relative length of the lines. For example, it may be useful to shorten the part of the cycle of motion in which the kite(s) are moving from high to low pull and lengthen the period when they are either pulling strongly or weakly. One method of achieving this is to add levers to the crankpins that are controlled in a way that accelerates the transition period. Another method of achieving this is to introduce a second device in front of the crankshaft which rotates in synchronisation with the crankshaft, though the use of a timing belt, and which includes elliptical discs that deflect the kite lines from their normal straight lines at certain periods of the cycle, thus shortening them.

Flywheels may be added to the crankshaft to ensure a smooth motion.

A device of single or dual discs can be added in front of the crankshaft to provide the option to connect more lines than there are crankpins. With a single disc, the back of the disc is connected to the crankpins by rods and the motion of the crankshaft therefore causes the disc to go through a swirling motion. Lines may then be attached at any point on the disc, allowing for many lines to be used without a proliferation of crankpins. Lines may also be attached to sliders on the disc, to alter the pitch of their movement as well as the timing of the movement. A second disc can be connected to a second set of crankpins and calibrated to move in an opposite pattern to the first disc, to allow pairs of lines to move relative to each other whilst attached to the same location on the front and back discs.

The crankshaft may be made in a spiral form, to allow lines to be attached at any point of the spiral and to allow their relative position to be easily adjusted to facilitate fine tuning of the settings. With spiral crankshafts, lines can be attached using bearings incorporating a quick release system that allows easy adjustment of the position of the bearings on the crankshaft. It may also be useful to use an angled ‘saddle’ device that sits between the spiral crankshaft and the bearing, allowing the bearing to rotate in the direction of spin of the crankshaft.

A ratchet system may also be used instead of a crankshaft. A ratchet operates in a similar manner to the freewheel system on a bicycle, such that it is connected to the axle in one direction or rotation, but not in the other direction. A simple version of this system can be used to exploit the energy from a single kite on a single line which goes through a cycle that generates varying force on the line. The line is attached to the ratchet so that when the line is pulling out strongly, the ratchet is rotating the axle and when the line is pulling less strongly, a spring or weight pulls in the line, without slowing significantly the continuous rotation of the axle or axles. In more complex versions, several ratchets can be attached to one or more axles.

A gearing system can be added, ideally with automatic gearshift, to enable the generation to continue more efficiently at different wind speeds.

Power can be generated from the rotating crankshaft in any number of conventional methods, for example, using a conventional alternator.

Reel and Lines. A number of devices may be incorporated into the reels and lines used to improve the efficiency and convenience of the system.

One of the problems faced in kite power generators is the tendency of the lines to drag in the wind and thus to introduce an element of elasticity in the response of the kite to the movement of the lines. One method for reducing this tendency is to place the lines in a common lightweight sleeve which therefore ensures that all lines experience the same drag. The sleeve may be tapered to reduce wind resistance. A sheath may be particularly useful in enabling the kite(s) to be flown at high altitudes to take advantage of stronger and more constant winds. The larger the kite, the easier it is to reach higher altitudes, as the wind resistance and stretch of the lines is smaller, relative to the forces on the lines.

Reels may be built which allow many lines to be wound together onto separate spools or onto different areas of the same spool. With separate spools, it may be useful to be able to lock them separately onto the axle of the reel to allow one or more to be wound in independently of the others. It can be useful to incorporate into the reel a device for applying friction so that it is possible for the kite to launch automatically without manual control of the outpull.

The lines of the kite can be attached to the crankshaft on spools. If these spools can be locked onto the crankshaft, then the crankshaft can also be used as a reel, removing the need for a separate reel.

It may not always be convenient for the kite lines to follow a straight line from the crankshaft to the kite or kites. This might occur, for example, because of a desire to house the crankshaft in a building or because a number of lines may want to be bunched together to reduce obstacles in the air or to ensure the lines approach the crankshaft from the same direction. In these circumstances, pulley devices can be used to allow the lines to turn corners whilst also moving backwards and forwards whilst minimising the loss of efficiency at the corner.

Specific examples of the kitepower generator apparatus and method will now be given:

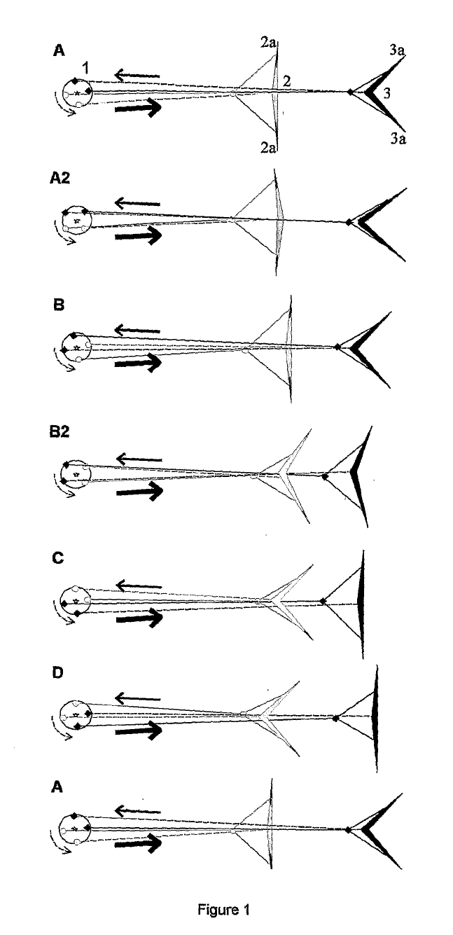

FIG. 1 describes the process of power generation through a crankshaft 1 cycle, illustrating a system with two kites 2, 3 in which the angle of the kite faces (or wings of the kite) to the wind is changed through a flapping cycle. In summary, when the wings are stretched square to the wind, they are pulling the crankshaft 1 out with a strong force and, when they are folded up, they are being pulled in by the crankshaft A, with a lesser force.

FIG. 1 describes four positions in the cycle (marked A to D) to demonstrate that, in each position, there is a net anti-clockwise force on the crankshaft 1. Two intermediate positions (A2 and B2) are also shown for added clarity. The solid arrows indicate forces, with the width of the arrow proportional to the strength of the force. The curved dashed arrow indicates the movement of the crankshaft 1.

In FIG. 1, the centre of rotation of the crankshaft is marked with a five pointed star. The lines to the first kite 2 are shown with a circular spot where they attach to the crankpins of the crankshaft 1. Another circular spot is used to show where one of the lines to the first kite 2 divides to attach to wings 2a of the kite 2. The attachment of the lines of the second kite 3 is similarly illustrated, but using diamonds instead of circles, to help to distinguish the lines.

It can be seen from a brief overview of FIG. 1 that the kites 2, 3 undergo a flapping motion as the crankshaft 1 rotates, the wings 2a, 3a of the respective kite 2, 3 kite moving toward and away from each other. The flapping motion in this configuration is similar to bird flight, except that the winged kites 2, 3 convert a fixed position in the sky into energy, whereas birds use energy to change position in the sky.

FIG. 1 illustrates the principle of operation of the invention. In general, the lines are pulled in and let out relative to each other in a manner that changes the resistance of the kites 2, 3 in the wind and therefore the strength of the pull on the kite lines. A device on the ground, such as a crankshaft 1, converts this cycle of forces on the kite lines into rotation, whilst also controlling the relative position of the kite lines and thus the orientation or shape of the kites 2, 3. As the leading line, or tether line, is pulling out, the second line, or power line, is nearer to the ground, thus keeping the respective kite square to the wind and generating a strong pull. As the cycle progresses, the tether line is pulled back in, followed by the power line. In this stage of the cycle, the power line is now further from the ground and this ensures that the kite adopts a position of low resistance to the wind, allowing the lines and the kite to be pulled relatively easily.

In relation to the Figure, it can be seen that the two kites 2, 3 are flown in a flow of air (i.e. wind). As one kite 3 is pulled away from the crankshaft by the wind, its lines pull on the crankpins of the crankshaft 1 and cause it to rotate. Due to the fact that each line is attached to a crankpin slightly offset from the other, there is a difference between the distance in which each line extends from the crankshaft 1. This difference causes the lines attached to the kite 3 to change the shape of the kite. It can be seen in FIG. 1 that the shape of the kite 3 changes so that its resistance to the wind increases (i.e. its wings 3a move away from one another), pulling the crankshaft around.

At the same time, the other kite 2 is being pulled toward the crankshaft 1 by its lines. Due to the fact that each line is attached to a crankpin slightly offset from the other, there is a difference between the distance in which each line extends from the crankshaft 1. This difference causes the lines attached to the kite 2 to change the shape of the kite. It can be seen that the shape of the kite 2 changes so that its resistance to the wind decreases (i.e. its wings 2a moves toward each other), allowing it to be pulled toward the crankshaft.

It will be appreciated that so long as there is some wind in which the kites 2, 3 may fly, the crankshaft 1 may be made to rotate continuously, meaning that power may be generated continuously. When the resistance of one kite is increasing to pull the crankshaft around, the resistance of another is being decreased so that it can be drawn toward the crankshaft. When one kite is finished pulling the crankshaft around, it's shape is altered by the motion of the crankshaft to reduce its resistance and pull it toward the crankshaft. At the same time, when the kite with decreased resistance has been drawn to towards the crankshaft, the motion of the crankshaft causes the resistance of the kite to increase, pulling the crankshaft around. It can be seen that this is a continuous cycle, imparting a cyclical pattern of forces on both the kite and the crankshaft.

Electrical power may be generated by attaching suitable apparatus to the crankshaft (e.g. incorporating the crankshaft in a generator of some kind).

As described above, it will be appreciated that crankshaft could be made to rotate using only one kite, but the motion of the crankshaft is smoother using two or more appropriately connected kites.

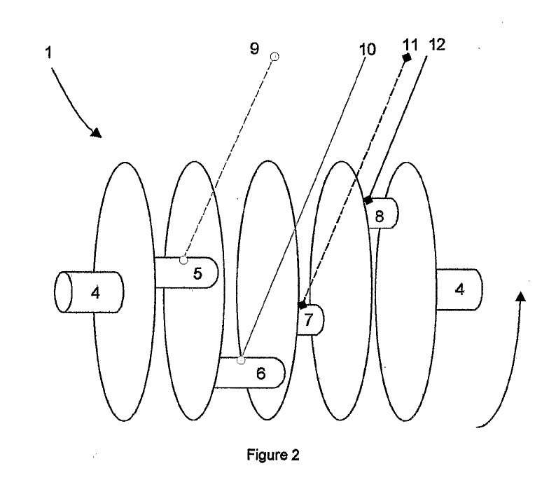

FIG. 2 describes the layout of the crankshaft 1. The crankshaft has an axis of rotation 4, referred to as the ‘main journal’ of the crankshaft 1. The crankshaft is provided with four crankpins 5, 6, 7, 8, to which are attached to four lines 9, 10, 11, 12. The tether line 9 to the centre of the first kite 2 (as seen in FIG. 1) is attached to a first crankpin 5. The power line 10 to the wings 2a of the first kite 2 is marked is attached to a second crankpin 6. The second kite 3 has a tether line 11 attached to a third crankpin 7, and a power line 12 attached to a fourth crankpin 8. The arrow indicates the direction of rotation of the crankshaft 1.

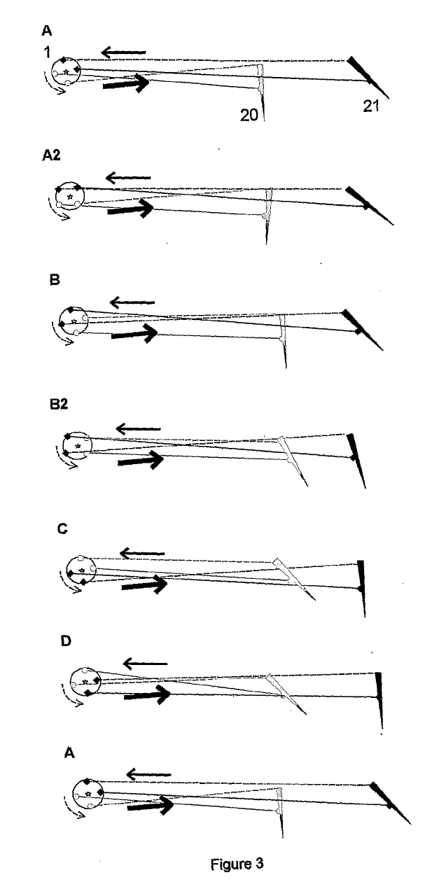

FIG. 3 describes another embodiment of the present invention. In this embodiment, two kites 20, 21 are again used to rotate the crankshaft 1 via lines attached to the kites 20, 21 and crankpins of the crankshaft 1. However, instead of the shape of the kites 20, 21 being changed by rotation of the crankshaft 1 (as in FIG. 1) the kites 20, 21 in this embodiment remain rigid. The kites 20, 21 go through a swooping cycle, as can be seen in steps A to Q and intermediate steps A2 and B2. The lines are attached to the fore and aft of each kite, so that the rotation of the crankshaft 1 causes the angle with which the kite faces the wind to change. The kites are drawn in when at a low angle of attack to the wind and pull out with a higher angle of attack.

The solid arrows indicate the forces acting on the crankshaft 1, with the width of the arrow proportional to the strength of the force. It can be seen that the forces always act to cause the crankshaft 1 to rotate in a given direction, shown by the curved dashed arrow.

In FIG. 1, the centre of rotation of the crankshaft is marked with a five pointed star. The lines to the first kite 20 are shown with a circular spot where they attach to the crankpins of the crankshaft 1. The attachment of the lines of the second kite 21 is similarly illustrated, but using diamonds instead of circles, to help to distinguish the lines.

Initially, the two kites 20, 21 are flown in a flow of air (i.e. wind). As one kite 21 is pulled away from the crankshaft 1 by the wind, its lines pull on the crankpins of the crankshaft 1 and cause it to rotate. Due to the fact that each line is attached to a crankpin slightly offset from the other, there is a difference between the distance in which each line extends from the crankshaft 1. This difference causes the lines attached to the kite 21 to change the orientation of the kite. It can be seen in FIG. 3 that the orientation of the kite 21 changes so that its resistance to the wind increases (i.e. so that the kite is more perpendicular to the wind), pulling the crankshaft 1 around.

At the same time, the other kite 20 is being pulled toward the crankshaft 1 by its lines. Due to the fact that each line is attached to a crankpin slightly offset from the other, there is a difference between the distance in which each line extends from the crankshaft 1. This difference causes the lines attached to the kite 20 to change the orientation of the kite 20. It can be seen that the orientation of the kite 20 changes so that its resistance to the wind decreases (so that the kite is more parallel to the wind), allowing it to be pulled toward the crankshaft 1.

As with the embodiment shown in FIG. 1, it will be appreciated that a continuous cycle is realised, ensuring that the crankshaft is continuously rotated and that power may be continually generated.

In a third embodiment, the kites remains rigid and power is generated by the kites veering from side to side. This option is not illustrated.

It will be appreciated that in the embodiments described above, the kites may be of any suitable design. For example the kites may be box kites, delta wings, parafoils or fixed wings, as is known in the art.

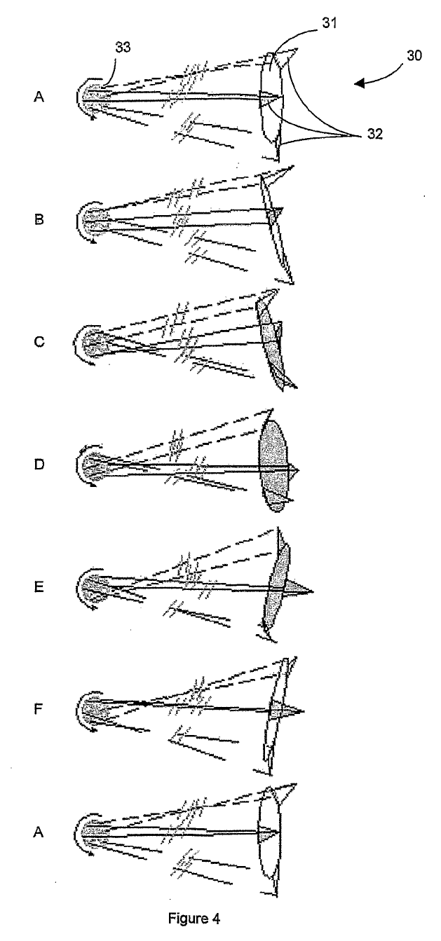

FIG. 4 shows another embodiment of the present invention, in which a single composite kite 30 is used in place of two or more separate kites shown in and described with reference to earlier Figures. To illustrate the three dimensional nature of the motion of the kite 30, the kite 30 is shaded assuming that the wind and sun are both coming from the left of the Figure. Thus, the parts of the kite 30 that are shaded are the ‘back’ of the kite 30.

The kite 30 contains a central element 31, with three ‘wings’, or flaps 32, attached to the side of the central element 31. The kite 30 goes through a ‘swirling’ motion, which involves each side moving forwards and backwards, with the wings 32 folded back on the side moving forward and outstretched on the side moving back. The kite 30 does not rotate. The swirling motion is depicted in the steps A-F in the Figure.

The central element 31 of the kite is presented as a circle in FIG. 4. It may involve a simple structure of spars, which keep three wings 32 at a fixed distance from each other. However, it may be useful to incorporate into the central element 31 some additional faces to provide the kite 30 with added lift and stability. These faces could use any suitable kite design that is associated with stability and lift, such as a box kite structure or a configuration of tetrahydra kite cells.

The wings 32 are attached to the side of the central element 31 at roughly equal distances around the edge of the central element 31. Each wing 32 is attached to two lines. The first line is attached on or close to the central element 31, and therefore controls the movement of the rim of the central element 31 of the kite 30 (and in general the overall movement of the kite 30). The second line is attached to the wing 32 away from the central element 31 and controls the flapping motion and the angle of attack of the wing 32. The lines are attached to crankpins on a crankshaft 33, using principles similar to that for separate kites, as described in FIGS. 1 and 2. The lines attached on or near the rim of the kite are the tether lines and the lines attached to the wings are the power lines.

When the wing 32 on one side of the kite 30 is fully outstretched (i.e. is generally parallel to the central element 31), it generates a strong outward pull on the lines, tugging that side of the kite backwards and causing rotation of the crankshaft 33. At the same time, the opposite side of the kite 30 is being pulled forwards by rotation of the crankshaft 33. Rotation of the crankshaft 33 causes the wing 32 on this opposite side to be folded back and away from the crankshaft 33 (i.e. such that it is not parallel with the central element 31). The air resistance of this opposite side of the kite 30 is therefore reduced, making it easier to pull the kite through the air. At the same time, rotation of the crankshaft 33 has caused another of the three wings 32 to be folded toward the crankshaft 33. As the crankshaft 33 rotates further, this wing is unfolded, which increases the air resistance of the side of the kite 30 to which it is attached.

It can be seen that each wing 32 undergoes a cyclical motion: folded away from the crankshaft 33, stretched parallel to the central element 31, folded toward the crankshaft 33, stretched parallel to the central element 31, folded away from the crankshaft 33, etc. Each wing's 32 cycle is out of phase with the others, meaning that as one wing 32 is pulling the crankshaft 33 around, another is folded away to allow a side of the kite 30 to be drawn toward the crankshaft 33, while the remaining wing 32 is ready to unfold to pull the crankshaft 33 around, and so on. This cyclical motion causes the kite 30 to continuously swirl in the air, which causes the crankshaft 33 to continuously rotate. This allows power to be generated continuously. It can be seen that power maybe generated passively, i.e. when the kite 30 is flown, no external control of the kite or crankshaft 33 is necessary.

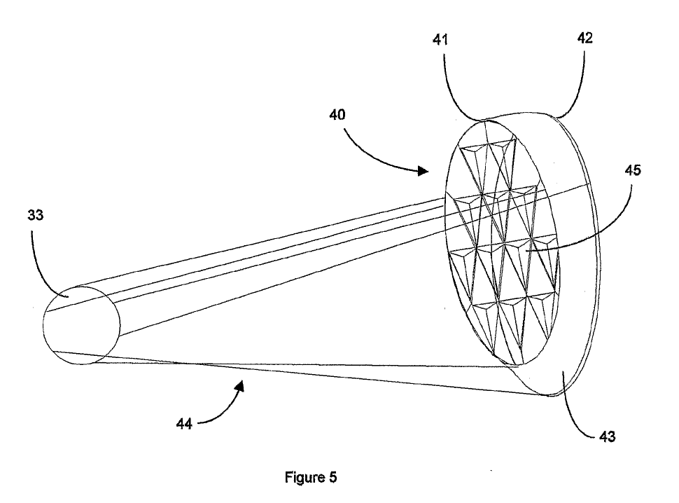

FIG. 5 shows another embodiment of the present invention. In this embodiment, a composite kite is used. However, in contrast to the composite kite of FIG. 4, the composite kite of FIG. 5 uses a swirling ring instead of wings.

Referring to FIG. 5, the kite 40 comprises two hoops 41, 42 connected by a ring, or skirt, of fabric 43. The kite 40 is attached to a crankshaft 33 using three pairs of lines 44, with the tether line of each pair attached to a first hoop 41 located near to the crankshaft 33, and the power line attached to a second hoop 42 located away from the crankshaft 33.

The swirling skirt 43 and hoops 41, 42 structures provided with an array of box cells 45 extending across the first hoop 41. The box cells 45 are of a tetrahydral design, and provide lift and stability to the whole kite 40 structure. A second array of box cells may be provided in the second hoop 42.

As the crankshaft 33 rotates, the relative position of the tether and power lines alters in the same manner as for kites in the embodiments described in relation to earlier Figures. When the lines 44 are pulling out, the power line pulls the skirt 43 in and to one side of the first hoop 41, thereby generating a strong pull. When the power line is let out, relative to the tether line, the skirt 43 falls back in line with the wind and therefore generates little resistance, as the lines are drawn in.

The motion of the skirt 43 is continuous, and continually pulls the crankshaft 33 in a certain rotational direction. This means that power may be generated continuously.

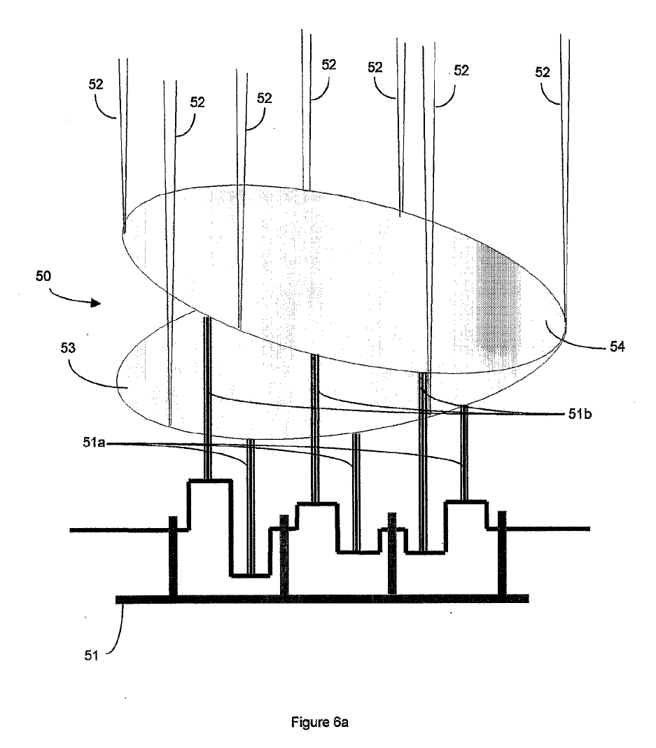

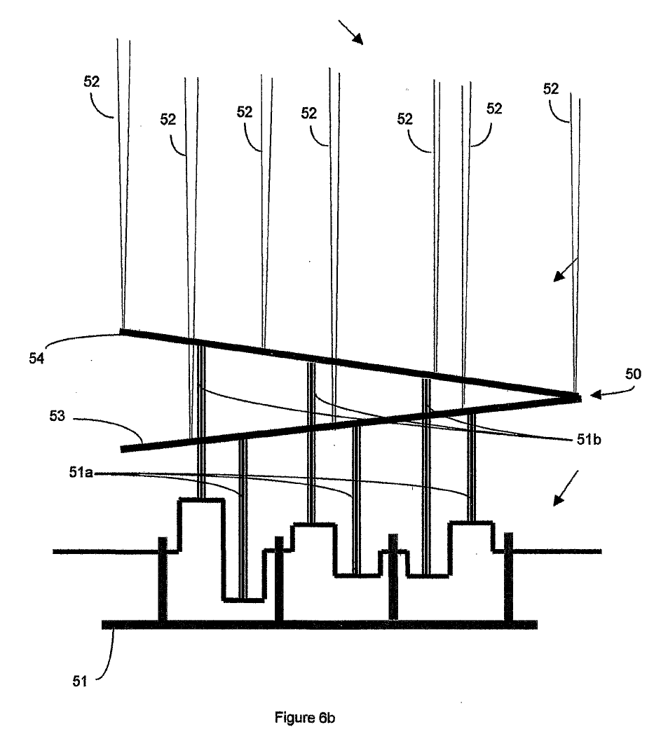

FIGS. 6a and 6b show a device 50 connected to a crankshaft 51 to allow many pairs of lines 52 to be attached to many kites or a single composite kite. FIG. 6a shows a perspective view of the device, and FIG. 6b shows a side view of the device.

This device is made from two rigid discs 53, 54, or other circular structures. A first disc 53 is located adjacent to the crankshaft 51, and is attached to three crankpins of the crankshaft 51 by three rods 51a. A second disc 54 is located away from the crankshaft 51, such that the first disc 52 is located between the second disc 54 and the crankshaft 51. The second disc 54 is attached to three other crankpins of the crankshaft 51 by three other rods 51b. The discs 53, 54 are connected to the crankshaft 51 in a manner that ensures that the peripheries of the discs 53, 54 are close on one side, whilst being apart on the other side.

As the crankshaft 51 rotates, the discs 53, 54 go through a swirling motion similar to that described in relation to the kites of FIGS. 4 and 5. As one side of a given disc 53, 54 moves toward the crankshaft 51, an opposite side moves away. The point at which the two discs 53, 54 meet moves round the periphery of the discs 53, 54. The purpose of the device 50 is to allow many kite lines to be attached to the crankshaft 51, without requiring a large number of crankpins. It can be seen that due to the swirling motion of the discs 53, 54, appropriately located lines can be used to maintain a similar swirling (or cyclical) motion of kites to which the lines are attached (no kites are shown in the Figure). Many lines can be used to connect the device 50 to a single composite kite to smooth out the cyclical pattern off forces acting on the kite and the crankshaft 51. Alternatively, many lines can be used to attach many kites the crankshaft 51 to smooth out the cyclical pattern off forces acting on the kite and the crankshaft. As described above, using a composite kite having many moving parts or using a plurality of kites to generate rotation is analogous to making a combustion engine run more smoothly by providing it with more cylinders.

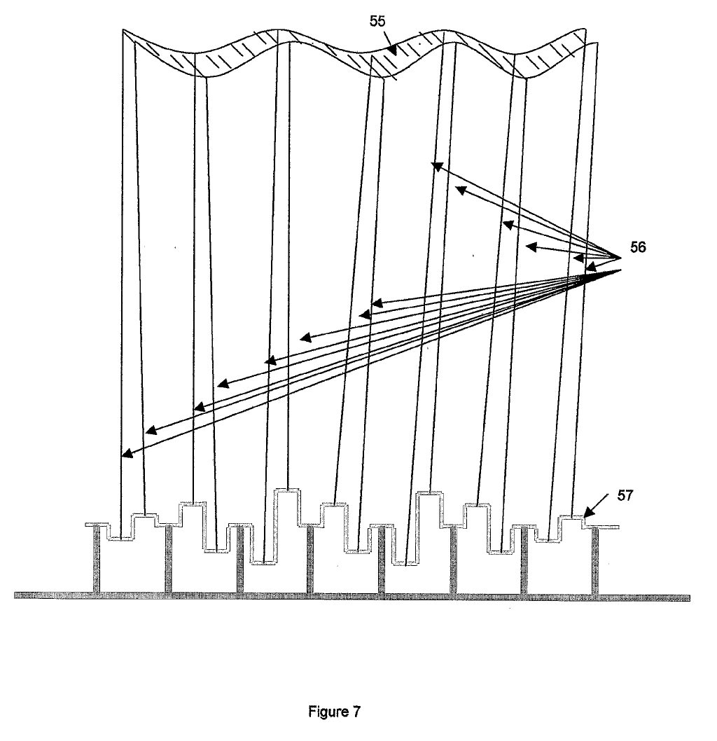

FIG. 7 shows an example of a kite that follows a wave pattern. For simplicity, the kite, 55, is shown as a single waving sheet, although in practice it would normally be necessary to produce the kite with an aerofoil cross-section. In the example, the kite is attached to the crankshaft, 57, with seven pairs of tether lines, 56. One of each pair of tether lines is connected to the leading edge of the kite and the other is connected to the trailing edge, behind the first line. The seven pairs of lines are connected at suitable positions along the length of the kite to ensure that the wave motion is regular. The configuration of lines and crankshaft will normally be symmetrical, so that the same movements occur on the left side of the kite as the right side.

As the crankshaft rotates, alternate lines pairs of lines are pulling the leading edge forward and down, while the trailing edges are being released upwards, therefore causing these parts of the kite to glide forward with little resistance. At the same time, the other parts of the kite are doing the opposite, with the leading edge tethers moving outwards, while the trailing edge tethers are pulled down, therefore allowing that part of the kite to catch the wind and pull strongly backwards. Because the force of the backward pull is stronger than the gliding in pull, the crankshaft is forced to rotate continuously.

The wave pattern may perform more reliably with a flexible leading edge spar, of a strength that is selected to allow enough flex, but not too much. It may also be useful to strengthen the cross-section of the kite with spars, especially at the points where the tether lines are connected.

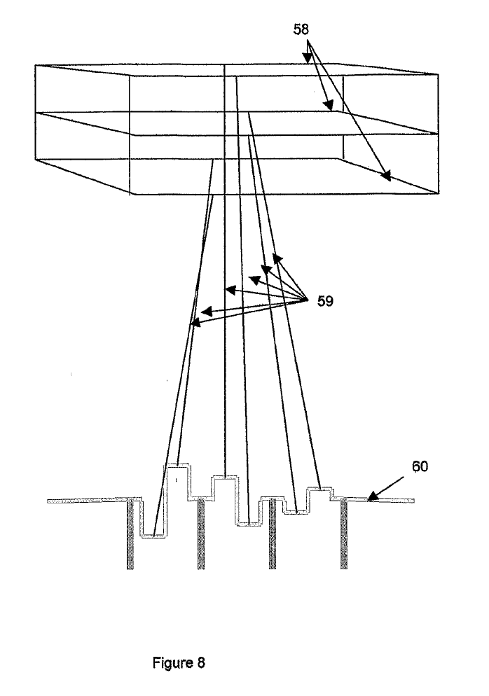

FIG. 8 shows an example of a vented kite. For simplicity, the kite structure is shown as three flat vents, panels or louvers, 58. In practice, each vent might be an aerofoil and the kite will also incorporate other structures to ensure that the whole kite stays aloft and behaves in a stable manner. In the example, the kite is connected by six tether lines, 59, to a crankshaft, 60, with six crankpins, in three pairs. Each pair of lines is attached to one vent, with one line near the front and another near the back. As the crankshaft rotates, each vent is first drawn down and forward towards the crankshaft and then raised up and drawn strongly backwards, as the front tether, and then the back tether pull outwards and the vent catches the wind. The outpull is therefore stronger than the inpull, causing the crankshaft to rotate in a manner similar to the other systems.

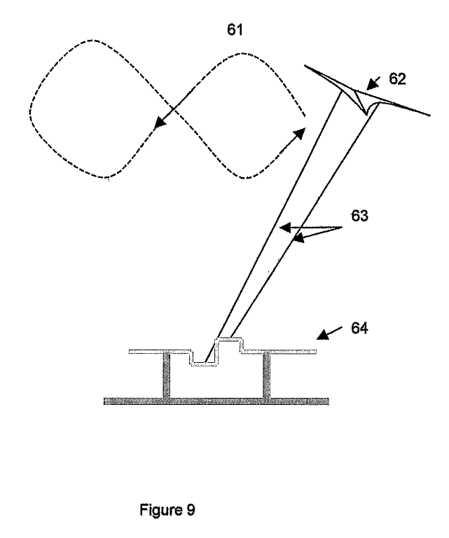

FIG. 9 shows the operation of a kite, 62, that is going through a figures of eight motion through the air, illustrated with the dashed line, 61. The kite illustrated is a delta kite, but the system works with other designs, as well. In the simple example illustrated, the kite is attached with two lines, 63, with one line on either side of the kite. These lines are attached to a crankshaft, 64, with two crankpins. The movement of the kite through the sky will be familiar to every stunt kite flier. As the right line is let out, the kite climbs strongly up, round and down the arc. Then, as the right line starts to be pulled in and the left line starts to let out, the kite moves more gently into the left outside of the figure of eight, before climbing on the other side of its cycle. As the left line is let out, the kite pulls strongly again, around the top of the left arc and down through the centre of the figure of eight. The system can be controlled more effectively with more than two lines attached to a crankshaft with more crankpins.

The cycle of movement may involve a large figure of eight, in which case the crankshaft will need to move slowly and some form of gearing will normally be required to increase the rate of rotation to speeds that are normally used by generators. However, the figure of eight cycle may also be tight and rapid, given the right kite and configuration of lines.

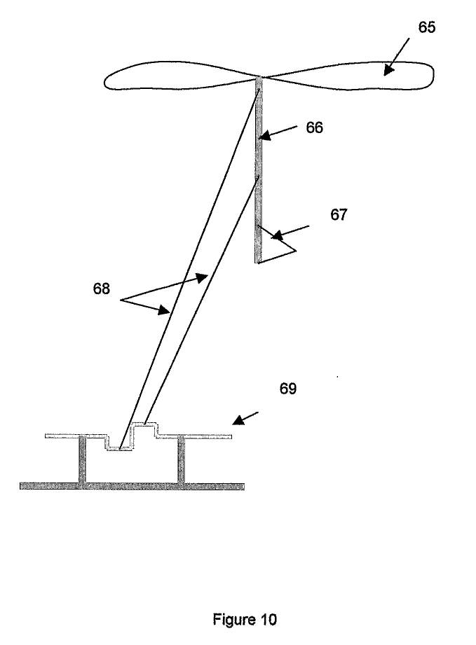

FIG. 10 shows a basic autogyro configuration. The diagram shows one position of the cycle of movement and shows a single autogyro only. However, attaching several autogyros to a crankshaft with more crankpins would normally be required to ensure smooth rotation, for reasons that apply to most kite power generator configurations. The autogyro is comprised of a rotating propeller, 65, on top of a shaft, 66, which helps to ensure the stability of the system. A flag, 67, may be attached to the bottom of the shaft to help stability. The autogyro is attached to a crankshaft, 69, by two lines, 68, attached at different points to the shaft. As the crankshaft rotates, the angle of the shaft thus changes. Experiments show that the changing angle of the shaft has a marked effect on the lift generated by the autogyro and this variation in lift is used to ensure that the crankshaft keeps rotating. The autogyro remains stable so long as the change in angle of the autogyro shaft is not too extreme and so long as the shaft is always straight or leaning backwards. The lines should not be rigged to pull the shaft forward, as this creates instability.

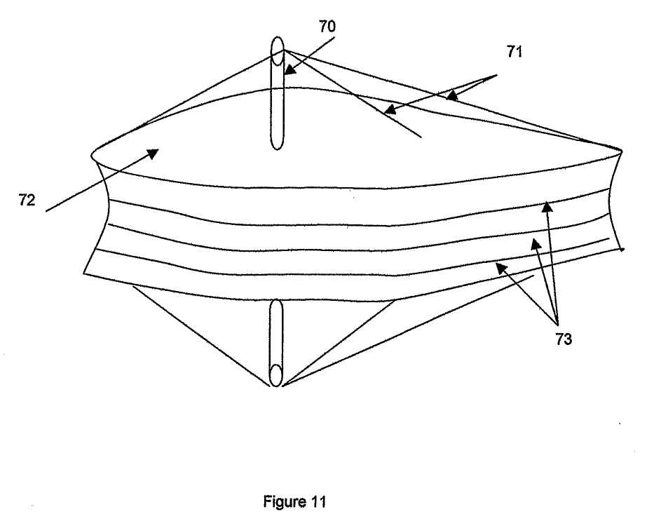

FIG. 11 shows a simple example of a tensioned aerofoil filled with a lighter than air substance. The aerofoil combines existing techniques for building parafoils and other blown-up aerofoils, with existing techniques for constructing tensioned aerofoil kites. In the diagram, the aerofoil is constructed in a manner similar to parafoils, with aerofoil shaped cells. Unlike parafoils, which allow air to enter the cells, 73, to ensure that they fill out and maintain their shape, the aerofoil in FIG. 11 is filled with a lighter than air substance and sealed. There are many examples of parafoils that have been filled with lighter than air substances to improve the performance of balloons. However, the tensioned aerofoil maintains its shape much better because it is pulled tight and stretched into a flatter shape, that is closer to a normal wing aerofoil. The stretching may be done in various ways. In the figure, it is done by putting a shaft, 70, through the centre of the aerofoil and then pulling the side of the aerofoil tight using several lines, 71. Another technique for tensioning the aerofoil is to bend a carbon fibre rod around the outside of the aerofoil. The regularity of the shape may be further improved by internal tension lines. It is also possible to construct the tensioned lighter-than-air aerofoil without using cells, by stretching two or more sheets of fabric into the appropriate shape, using further lines or spacing rods to create the shape and volume of the aerofoil, in which is held the lighter than air substance. Because the shape of the aerofoil is maintained by tensioning it is not necessary for the lighter than air substance to be under any pressure, and this helps to avoid the bulging shapes that harm the performance of conventional parafoils filled with lighter than air substances.

Maintaining a relatively streamlined shape for the aerofoil is important to the ability of the kite to perform in higher winds. It is possible to incorporate lightweight micro pore lattice materials into the kite, to help maintain the shape, whilst also allowing the shape to be filled with lighter than air substances. Aerogels are examples of such lattices, in which, for example, a light foam is filled with a lighter than air substance and hence results in a firm material that is also lighter than air.

It will be appreciated that kite power generators may be designed to incorporate a combination of the various designs and features described above.

It will be appreciated that the embodiments described above have been given by way of example only. It will be appreciated that various modifications may be made to these and indeed other embodiments without departing from the scope of the invention, which is defined by the claims that follow.

1-45. (canceled)

46: A power generator system for converting a pattern of forces in kite lines into a rotational movement on the ground for generating power, power generator system comprising:
at least one kite;
at least one line connectable to said kite; and
a moveable device connectable to said line, wherein the shape or orientation of said kite is changeable to, in use, impart a first cyclical pattern of forces on said moveable device via said line, said first cyclical pattern of forces being configured to cause said moveable device to move in a cyclical manner and generate power.

47: The power generator system as set forth in claim 46, wherein movement of said moveable device is, via said line, arranged to impart a second cyclical pattern of forces on said kite in order to change the orientation or shape of said kite, the changing of the orientation of shape of said kite being configured to cause said kite to impart said first cyclical pattern of forces on said moveable device.

48: The power generator system as set forth in claim 47, wherein said line is at least two tether lines connectable to said moveable device and said kite.

49: The power generator system as set forth in claim 48, wherein said moveable device is a rotatable device, with each of said two lines being connectable to a different point on said rotatable device.

50: The power generator system as set forth in claim 49, wherein said two lines being defined as a first line and a second line, wherein said first line is attached to a first point on said rotatable device and said second line is attached to a second point on said rotatable device, said first point being in advance of said second point in the direction of rotation of said rotatable device when it is moving to generate power, said two lines being attachable to said kite in such a way that when said rotatable device rotates to draw in said first line and impart said second cyclical pattern of forces on said kite, at least a part of said kite is drawn towards said rotatable device, the orientation or shape of said kite being changed to reduce the kite's fluid resistance, and when said rotatable device rotates to let out said first line, at least a part of said kite is allowed to move away from said rotatable device, the orientation or shape of said kite being changed to increase the kite's fluid resistance to impart said first cyclical pattern of forces on said rotatable device.

51: The power generator system as set forth in claim 49, wherein said rotatable device is a crankshaft, each of said two lines being connectable to a crankpin of said crankshaft.

52: The power generator system as set forth in claim 51, wherein said two lines being defined as a first line and a second line, wherein said first line is attachable to a first crankpin and said second line is attached to a second crankpin, said first crankpin being in advance of said second crankpin in the direction of rotation of a crankshaft when it is moving to generate power, said two lines being attached to said kite in such a way that when said crankshaft rotates to draw in said first line and impart said second cyclical pattern of forces on said kite, at least a part of said kite is drawn towards said crankshaft, the orientation or shape of said kite being changed to reduce the kite's fluid resistance, and when said crankshaft rotates to let out said first line, at least a part of said kite is allowed to move away from said crankshaft, the orientation or shape of said kite being changed to increase the kite's fluid resistance to impart said first cyclical pattern of forces on said crankshaft.

53: The power generator system as set forth in claim 52, wherein said crankshaft also operates as a reel wherein said crankpins are spools which can be locked and unlocked onto said crankshaft so that, when locked, the rotation of said crankshaft reefs in said lines.

54: The power generator system as set forth in claim 52 further comprising a device in front of said crankshaft that consists of at least one rigid disc connectable to rods attached to said crankpins so that said disc swirl in line with said crankshaft movement, thus allowing said lines to be attachable at any point on said disc offering full flexibility as to the number of said lines and their relative movement.

55: The power generator system as set forth in claim 48, wherein said kite being adapted to hingedly move up and down and/or back and forward about a central line with one of said lines attachable to said central line and the other of said lines attachable nearer an end of said kite, either directly from beneath or through the centre and up to a shoulder and then down to said kite from above.

56: The power generator system as set forth in claim 48, wherein said kite swirls around a stable central point, with said tether lines attachable to the periphery, and with the shape of said kite changing as a result of support structures selected from the group consisting of flaps, wings, skirts, and sliding structures, so that the lift and/or drag from sides of said kite changes, with one side pulling out strongly, whilst the opposite side is being pulled in with less force, and with the pattern of forces migrating around said kite, as it changes shape.

57: The power generator as set forth in claim 48, wherein said kite changes form in a wave pattern, either as a resulting of naturally changing forces within said kite or as a result of the changing positions of said tether lines, such that the forces on said tether lines change as the parts of said kite they are attached to go through the different stages in the wave pattern.

58: The power generator as set forth in claim 48, wherein said kite goes through a spinning motion in an axis perpendicular when placed in a flow in a manner which causes said kite to vary the force on said tether lines.

59: The power generator as set forth in claim 48, wherein said kite or kites go through a regular pattern of movement through the sky which generates varying forces on its tethers at different stages of the flight.

60: The power generator system as set forth in claim 49, wherein said rotatable device is at least one ratchet on at least one axle, said ratchet being adapted to rotate said axle when said kite is pulling said lines out, and when the change in orientation or shape of said kite reduces the pull on said lines, said lines are pulled in by a spring or weight, without slowing the continuous rotation of said ratchet.

61: The power generator system as set forth in claim 46, wherein said kite further comprising a lighter than air substance to enable said kite to stay aloft.

62: The power generator system as set forth in claim 61, wherein said kite further comprising an aerofoil shape structure filled with said lighter than air substances, said aerofoil shape structure being shaped by a system selected from the group consisting of tension, an internal lightweight fan structure, a micro pore lattice material, and foam.

63: The power generator system as set forth in claim 46 further comprising a reel device and a cradle, said reel device being adapted to reel in said kite automatically during periods of weak and strong winds, and said cradle being adapted to catch said kite automatically in such a way that said kite will relaunch automatically when the wind returns to working strengths.

64: The power generator system as set forth in claim 46, wherein said kite further comprising self-furling mechanisms through the use of flexible material, changing structures, stretchable tether lines and devices to alter shorten selected tether lines, thus allowing said kite to flexibly change it's shape, to create greater lift and/or drag in weak winds and lower lift and/or draft in high winds, thereby extending the weather window in which said kite will operate and to reduce damage to the fabric of said kite.

65: The power generator system as set forth in claim 46 further comprising a system wherein power is selected from the group consisting of electricity, a system of weights, a system of springs, and human force, is applied to drive said rotatable device in the opposite direction during periods of light or no wind, in order to force said kite to reverse its cycle of motion and to generate lift to stay aloft.

66: The power generator system as set forth in claim 51 further comprising a system that is added to said crankshaft to alter the relative movement or length of said tether lines to influence the relative forces on said crankshaft in order to reduce the proportion of the cycle spent in transition between high and low pull.

67: The power generator system as set forth in claim 48 further comprising a sleeve adapted to house said lines, so that said lines are subject to a single uniform drag that reduces the combined drag of separate said lines and the tangling of said lines, and also reduces the variability in force between said lines.

68: The power generator system as set forth in claim 48, wherein said kite further comprising a plurality of vents that close and open to generate varying lifting forces on said kite.

69: The power generator system as set forth in claim 48, wherein said kite is an auto-gyro kite which alters its angle of attack toward the wind, thus altering the lift generated and the pull on said lines.

70: A power generator system comprising:
at least one kite;
at least two lines connectable to said kite, said two lines being defined as a first line and a second line; and
a rotatable device, being a crankshaft, connectable to said first and second lines at different points, said rotatable device having a first pin attachable to said first line, a second pin attachable to said second line; and
wherein the shape or orientation of said kite is changeable to, in use, impart a first cyclical pattern of forces on said crankshaft via said first and second lines, said first cyclical pattern of forces being configured to cause said crankshaft to rotate, and wherein rotation of said crankshaft is, via said first and second lines, arranged to impart a second cyclical pattern of forces on said kite in order to change the orientation or shape of said kite, the changing of the orientation of shape of said kite being configured to cause said kite to impart said first cyclical pattern of forces on said crankshaft;
wherein said first crankpin being in advance of said second crankpin in the direction of rotation of said crankshaft when it is moving to generate power, said first and second lines being attached to said kite in such a way that when said crankshaft rotates to draw in said first line and impart said second cyclical pattern of forces on said kite, at least a part of said kite is drawn towards said crankshaft, the orientation or shape of said kite being changed to reduce the kite's resistance, and when said crankshaft rotates to let out said first line, at least a part of said kite is allowed to move away from said crankshaft, the orientation or shape of said kite being changed to increase the kite's resistance to impart said first cyclical pattern of forces on said crankshaft.

71: The power generator system as set forth in claim 70, wherein said kite further comprising an aerofoil shape structure filled with a lighter than air substance, said aerofoil shape structure being shaped by a system selected from the group consisting of tension, an internal lightweight fan structure, a micro pore lattice material, and foam.

72: A method of generating power using a power generator system, said method comprising the steps of:
providing a power generator system comprising: at least one kite; at least one line connectable to said kite; and a moveable device connectable to said line, wherein the shape or orientation of said kite is changeable to, in use, impart a first cyclical pattern of forces on said moveable device via said line, said first cyclical pattern of forces being configured to cause said moveable device to move in a cyclical manner and generate power;
locating said kite in a fluid or gas flow so that said kite pulls against said moveable device;
changing the shape or orientation of said kite to impart a first pattern of cyclical forces on said moveable device to move said moveable device to produce a rotational movement connectable to a power generator thereby generating power;
imparting a second cyclical pattern of forces, through movement of said moveable device, on said kite to change its shape or orientation;
drawing at least a part of said kite towards said moveable device through movement of said moveable device causing said kite to change its shape or orientation to reduce the kite's fluid resistance; and
drawing at least a part of said kite away from said moveable device through movement of said moveable device causing said kite to change its shape or orientation to increase the kite's fluid resistance and moving said moveable device.
